(19) United States
(12) Patent Application Publication
(10) Pub. No.: US 2002/0191179 A1
(43) Pub. Date: Dec. 19, 2002

(54) Measurement of surface defects

(76) Inventors: Teunis Willem Tukker, Eindhoven (NL); Gert Wim ' T Hooft, Eindhoven (NL)

Correspondence Address: Corporte Patent Counsel, Philps Electronics North America Corporation, 580 White Plains Road, Tarrytown, NY, 10591, US

(21) Appl. No.: 10/169,819

(22) PCT Filed: Nov. 8, 2001
(86) PCT No.: PCT/EP01/13042

(30) Foreign Application Priority Data
Nov. 13, 2000 (EP) 00203979.0

(51) Int. Cl. G01N 21/88

(52) U.S. Cl. 356/237.2

(57) ABSTRACT

A device 1 for the inspection of one or a plurality of moving surfaces 8, more particularly for the inspection of a rotating surface 8 of a silicon wafer 13. The device comprises at least a laser light source 1 and a beam splitter 4 for splitting a light beam 2 that is emitted by said light source 1 into at least two sub-beams 5, 6 that interfere with one another so as to produce an interference pattern 10 on the surface 8 to be inspected. The device is arranged so that the interference pattern 10 contains a plurality of lines 11 of maximum intensity and lines 12 of minimum intensity, said lines extending essentially transversely of the direction of movement of the surface 8.

The invention relates to a device for the inspection of surfaces as disclosed in the introductory part of claim 1, as well as to a method as disclosed in the introductory part of claim 13.

WO 97/34124 teaches the use of a laser for the inspection of surfaces; the beam emitted by said laser is first split into two sub-beams in a beam splitter and said sub-beams interfere with one another in an optical cube or prism in the further course of the optical beam path, the interference pattern produced by the interference of the sub-beams then being imaged on the surface to be inspected. Imaging is performed via a cylindrical lens so that in the case of a standard wafer the region irradiated on the surface may extend radially approximately from its center to its periphery. The intensity of the light reflected at the surface changes in response to the occurrence of surface defects, so that an intensity measurement that is performed by the detector in a space resolved manner enables the localization of defects. The sensitivity is limited and amounts to approximately 500 nm. Such a sensitivity, however, is not adequate for the microstructures with conductor tracks or component groups that are situated very close to one another. In order to enhance the sensitivity, it would be necessary to reduce the irradiated region. However, the measurement would then become very time consuming. Moreover, the detector is continuously exposed to the reflected light, thus giving rise to a serious disturbance due to background effects.

It is an object of the invention to enhance the measurement of contaminations or damage on surfaces.

The object is achieved in accordance with the invention by means of a device as disclosed in the characterizing part of claim 1 as well as by means of a method as disclosed in the characterizing part of claim 13. Reference is made to the claims 2 to 12 and 14 for advantageous further embodiments of the invention.

Because of the construction of the device in accordance with the invention, where the interference pattern imaged on the surface has lines of maximum intensity or lines of minimum intensity that extend transversely of the direction of movement of the surface, each defect present and detected on the surface (for example, a particle that rests thereon or a damaged spot that extends inwards) crosses several lines of different intensity. A corresponding scatter image of the applied light is then produced, which scatter image can be simply evaluated because of its bright/dark distribution that is finely resolved across the various interference lines. The resolution is substantially finer than the size of the light spot. Therefore, despite the desired high resolution, a comparatively large light spot can be used so that the time required for scanning the surface is reduced.

When an elliptical light spot is formed with major axis that extends in the radial direction for the inspection of an approximately round wafer (provided with a cut-out for recognizing the orientation), defects in different radial positions on the surface to be inspected will traverse different regions of the light spot. Because the defects that are situated further outwards in the radial direction must travel a distance per unit of time which is larger than that traveled by defects that are situated further inwards, their speed is increased; this results in a narrower detected intensity image. The radial position of the defect can thus be localized. The invention thus enables exact determination of the position of the detected defect by way of a velocity measurement.

There is also envisaged a detection for the instantaneous orientation of the surface, for example, in a decoder that is associated with the rotary drive of the wafer, so that additionally, for example, the angular position of a wafer can be determined upon detection of a defect. The pole co-ordinates of the defect thus become fully known. Exact localization is then possible.

Further advantages and details of the invention will become apparent from the embodiments of the invention that are described in detail hereinafter with reference to the drawing.

In the drawing:

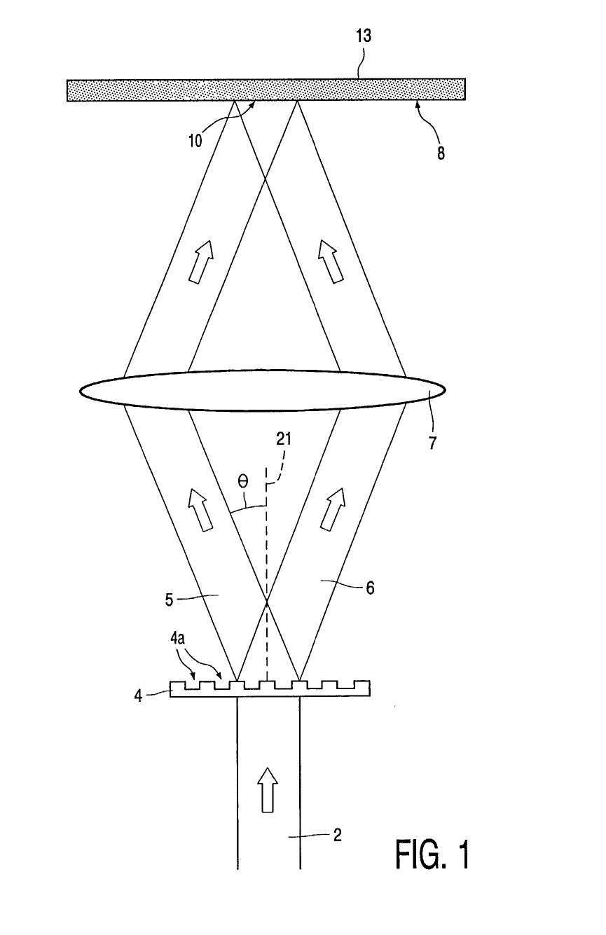

FIG. 1 is a diagrammatic representation of a first embodiment of the part of the device that irradiates the surface,

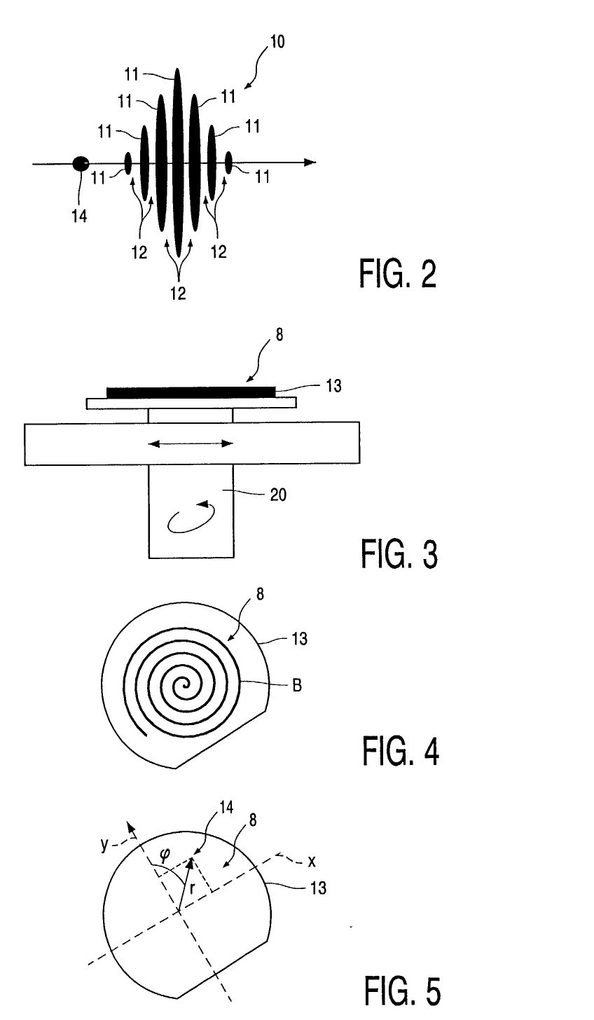

FIG. 2 is a diagrammatic, compressed representation of the interference pattern that is formed on the sample to be inspected, that is, briefly before the passage of a particle,

FIG. 3 is a side elevation of a sample holder,

FIG. 4 is a plan view of the surface to be inspected, the trajectory of the sample also being indicated,

FIG. 5 is a view similar to that of FIG. 4 with inserted Cartesian and pole coordinates of a surface defect,

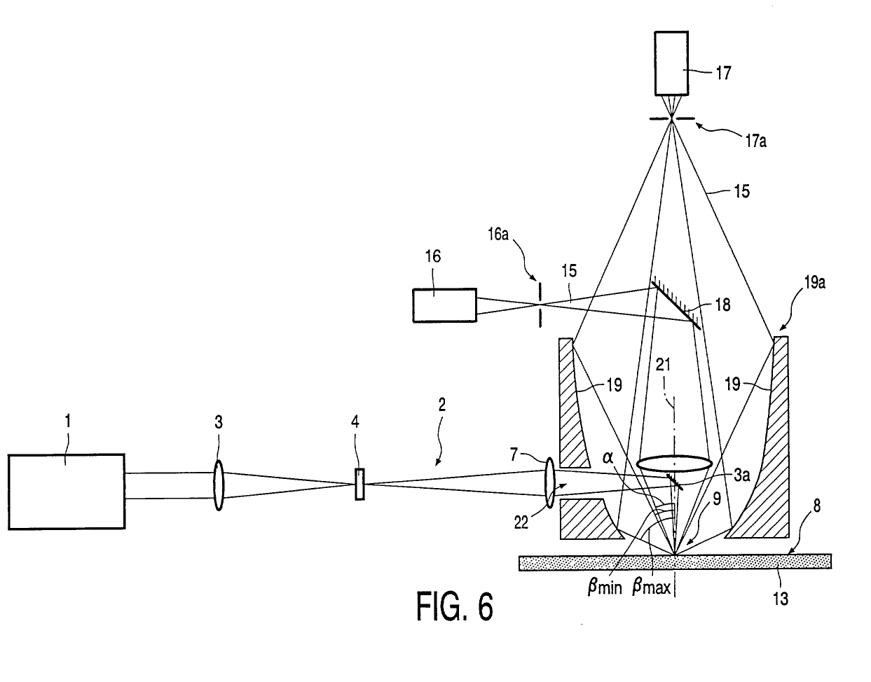

FIG. 6 is a diagrammatic overall view of a second embodiment of a device in accordance with the invention,

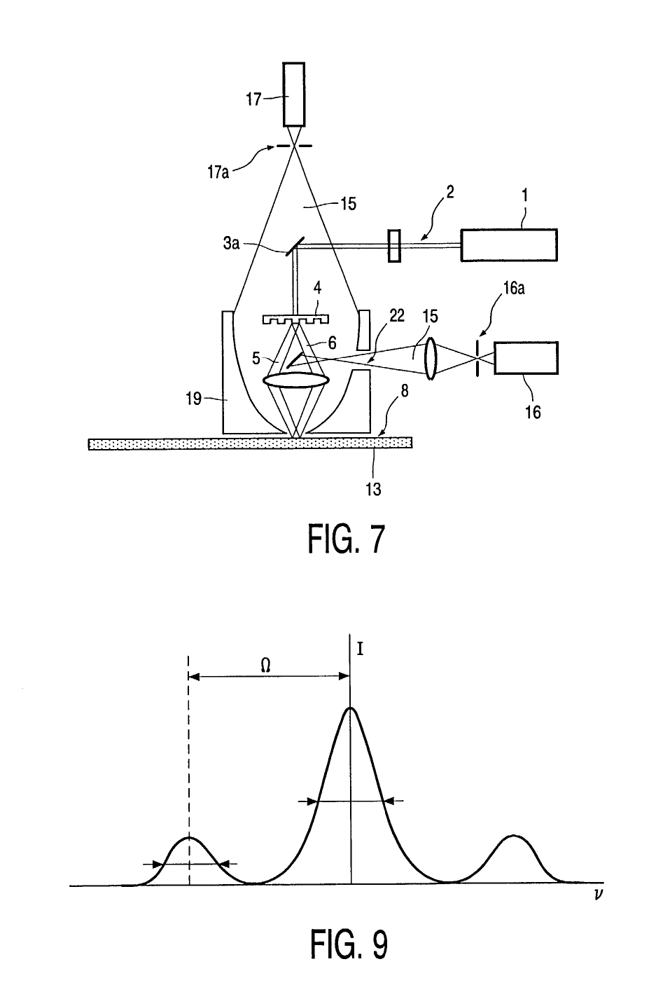

FIG. 7 is a diagrammatic overall view of a third embodiment of a device in accordance with the invention,

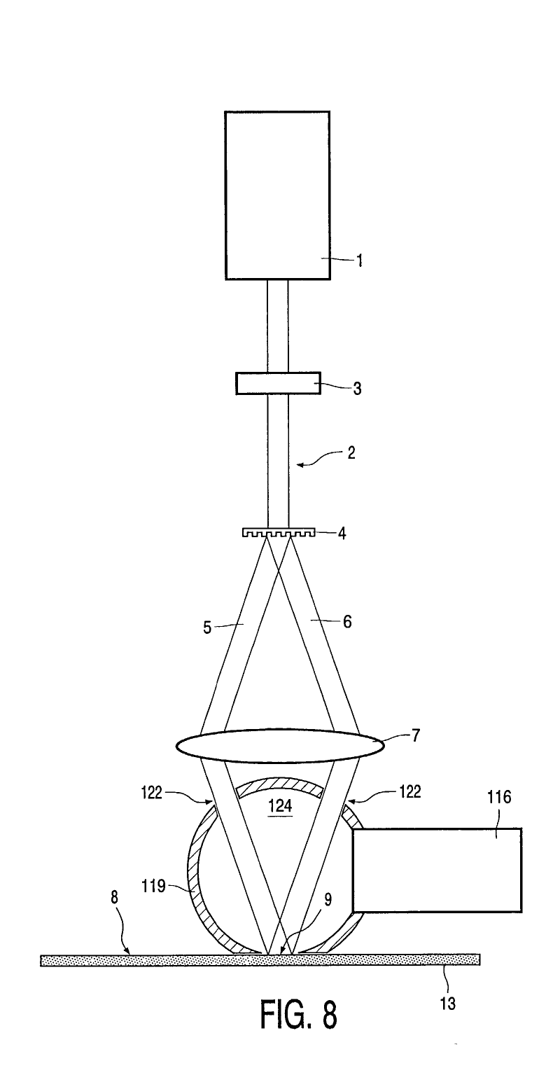

FIG. 8 is a diagrammatic overall view of a device in accordance with the invention with the first embodiment of the parts irradiating the surface as shown in FIG. 1,

FIG. 9 is a diagrammatic representation of the scatter spectrum of a defect,

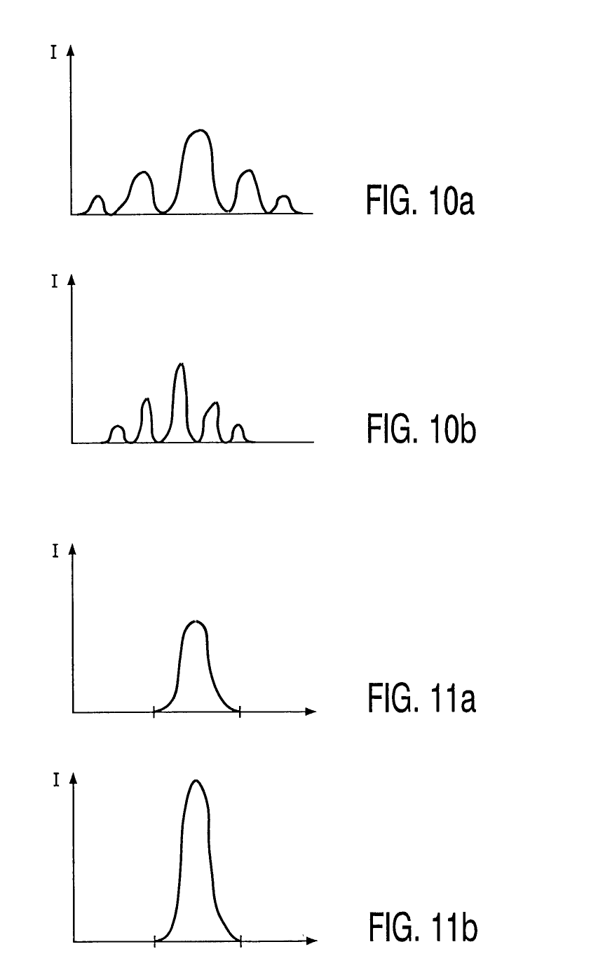

FIG. 10 shows the signal intensity I obtained for a defect (a) that is situated radially inwards and a defect (b) that is situated radially further outwards, and

FIG. 11 shows the respective signal obtained from a small surface defect (a) and a large surface defect (b), measured by means of the second detector.

The first embodiment of the device 1 as shown in the FIGS. 1 and 8 includes a light source 1 which is preferably constructed as a laser light source because of the desired interference and high intensity. However, the use of a laser light source is not absolutely necessary, since a beam splitter 4 arranged in the emitted beam 2 could also lead to interference of the beams 5 and 6 split off from the original beam 2 in the case of light rays of small coherence length only. The laser 1 continuously produces monochromatic light, that is, approximately in the visible range and typically of a wavelength of, for example 488 nm. Even though use can be made of a light source with a shorter wavelength so as to improve the sensitivity, the scatter cross-section of the light with the air surrounding the surface then also increases. Granted, a measurement in a helium atmosphere or in vacuum conditions is also possible in theory, but would be very expensive.

A beam splitter 4 is arranged in the beam path of the beam emitted by the laser 1. The beam splitter may be constructed in various ways, for example as Fresnel's mirrors, as a double gap, as a combination of a polarizing optical cube and a λ/2 plate, or as another known mechanism. The present embodiment is provided with a grid 4 which conducts the split light beams, the first-order beams 5, 6 of which are shown in FIG. 1, in a common plane in which overlapping and interference occur. A sinusoidal grid can be used so as to achieve ideal splitting into two beams. For two-beam interference only the first orders are used. In order to remove higher orders, for example, a converging optical system 7 (for example, a lens) is arranged subsequent to the grid 4, its aperture being limited in such a manner that beams of higher order are not imaged. The zero order can be removed already by means of a suitable grid 4 or a non-transparent region is provided for the subsequent optical system 7, for example in the central region of a lens. It is also possible to use a diaphragm which comprises apertures for the first-order beams only.

In order to achieve uniform illumination of the grid 4, it is preceded by a collimator 3 in the optical beam path, said collimator being a cylindrical lens in the present case. This collimator ensures parallel incidence of light on the grid 4. The converging effect of the lens 3 is necessary in the plane in which the grid column 4a extends. The lens 3 also ensures that the grid 4 is uniformly illuminated within an essentially elliptical region, so that the interference pattern 10 arising behind the grid 4 also has an elliptical contour.

The split beams 5, 6 subsequent to the beam splitter 4 are applied to the already mentioned collimating optical system 7 which is in this case a converging lens as shown.

Subsequently, the beam 2 is guided to the moving surface 8 to be inspected on which it forms a light spot 9 with an interference pattern 10. The interference pattern 10 is formed only on the surface 8, that is, not already during the recombination of the light beams 5, 6 that takes place in front of the surface 8. Projection of a previously formed interference pattern can thus be dispensed with; a component for recombining the split beams 5, 6 and an optical system for imaging such an interference pattern can thus also be dispensed with. The interference pattern 10 contains lines of maximum intensity 111 and lines of minimum intensity 12, all of which lines extend in the direction parallel to the orientation of the grid column 4a. The lines 11 of maximum intensity correspond to constructive interference with a sin θ=mλ, where a is the grid constant, λ is the wavelength of the applied light beam 2, and θ is the deflection angle. The integer m indicates the order. In the present embodiment only the first-order beams (m=±1) are made to interfere.

When a suitable optical system is chosen, for example, the cylindrical lens 3 and/or the said further lens 7 or one or more mirrors that are also capable of achieving beam deflection (FIG. 6), it is ensured that the light spot 9 on the surface 8 has an elliptical appearance. For exact determination of the position, the ellipse 9 has a narrow shape. In order to achieve a short measuring time, it has a large dimension in the radial direction. A practical shape of the light spot 9 is, for example 2 mm×40 μm. When a surface 8 is irradiated which forms part of a round, rotationally moved member 13, for example a wafer, the major semi-axis of the ellipse 10 extends preferably in the radial direction of the wafer 13. A wide circular strip on the surface 8 can thus be scanned during the rotation of the wafer 13.

The light spot 9 can be moved by way of a movable optical system, that is, in this case in the radial direction of the wafer 13 to be inspected, thus enabling complete scanning of the surface 8 thereof. It is advantageously possible to keep the entire optical system that influences the incident beam 2 (which must be very accurately adjusted because of the required accuracy) stationary instead and to make the wafer 13 carry out, in addition to the rotary movement, a superposed translatory movement so that the spiral-like trajectory B of the object 13 as shown in FIG. 4 is obtained. The light spot 9 retains its position and the wafer 13 is moved underneath the light spot in such a manner that its surface 8 can be completely scanned.

The circular frequency co of the surface 8 examined is constant; any defects present, therefore, pass underneath the interference lines 11, 12, that is, in the direction transversely of their major dimension, at a constant circular frequency ω. Depending on the radial position of a defect 14, it traverses the light spot 9 with a different staying time, because the speed of revolution v=ωr, where r=radial distance between the defect 14 and the center, is higher for particles that are situated further outwards than for a defect that is situated further inwards.

The sample 13 is mounted on a sample holder 20. With the sample holder there is associated a decoder for detecting an instantaneous position, in this case being an angular position. When a defect 14 occurs, the relevant angle of rotation of the sample holder 20 can thus be determined during the passage of the defect 14 through the light spot 9.

The light 15 from the surface 8 is conducted to a first light-sensitive detector 16 and to a second light-sensitive detector 17. The two detectors 16, 17 need not detect in a space resolved manner. It is not absolutely necessary either to use two detectors 16, 17.

The first detector 16 is arranged transversely of the surface. A mirror 18 serves to deflect the reflected light; the light that is reflected perpendicularly from the surface 8 is deflected through 90° by said mirror and is conducted directly or indirectly to the entrance window of the first detector 16. The dimensions of the mirror 18 are only small. Consequently, only light beams that are scattered at a small angle α relative to the perpendicular 21 to the surface 8 are conducted to the entrance window of the first detector 16.

The second detector 17 is arranged perpendicularly above the light spot 9 that is incident on the surface 8. In order to enable the light to be conducted to this detector, there are provided collectors 19 which are constructed as elliptical collectors that laterally bound the beam path of the reflected light. The collectors 19, being arranged outside the contour of the light spot 9, are reached exclusively by light beams 15 that are scattered at a large angle β relative to the perpendicular 21 to the surface 8. The upper edge 19a then imposes a minimum angle βₘᵢₙ. When reflected light beams 15 extend at a smaller angle relative to the perpendicular 21, they are not detected by the second detector 17. Light beams 15 that extend at an angle greater than βₘₐₓ relative to the perpendicular 21 do not reach the collectors 19 either so that they are not detected by the second detector 17. The outer collectors 19 may be provided with an entrance window 22 in the form of a cut-out wherethrough the light beam 2 emanating from the laser 1 can pass.

The entrance windows of the detectors 16, 17 are also preceded by diaphragms 16a, 17a which bound the measuring volume and suppress background noise. Because the input signal of the detectors 16, 17 is modulated with the frequency of the interference pattern 10, the acquisition of the measuring signal may also be performed in such a manner that evaluation takes place only for signals that have the appropriate frequency within a measuring window between the minimum frequency and the maximum frequency, that is, in conformity with the respective radial position of a defect, if any. Any signals that are due to scattering on air and do not have this frequency are thus filtered out.

FIG. 7 shows a second embodiment which clarifies that the incident light beam 2 can also enter above the reflected light beam 15 and can be deflected by a mirror 3a prior to being split by the grid 4. There are no fundamental differences with respect to the first embodiment.

FIG. 8 shows a third embodiment in which the light source I is arranged perpendicularly to the surface 8. The incident light beam 2 thus need not be deflected and the mirror 3a can be dispensed with. The split light beams 5, 6 enter, via two entrance windows 122, a closed measuring chamber 124 which is bounded by reflecting, spherical walls 119. Only one detector 116 is provided. All of the reflected light 15 is conducted to the detector 116 by the walls 119.

It will be evident that the light source 1, the surface 8 and the detectors 16, 17 can be arranged in a variety of ways and that such an arrangement can be realized by selection of suitable deflecting and converging optical systems. It is not necessary either, of course, that the light 2 is incident on the surface 8 from above; it may also enter from below or be oriented in a different way. The detectors 16, 17 are constructed as photoelectric detectors in any known way and hence convert a light signal into an electrical signal. Secondary electron multipliers (SEV) can typically be used in the detectors 16, 17.

The function of the device 1 and the method in accordance with the invention will be explained on the basis of the second embodiment (FIG. 6).

During the entire measurement of a surface 8 the applied light 2 is incident on the surface 8 within a light spot 9 that remains constant and generates at that area the interference pattern 10 with the lines of maximum intensity 111 and minimum intensity 12 which are oriented radially with respect to the surface 8.

In the case of an ideally smooth surface 8, the light is reflected (except for the scattering on air molecules) subject to the deflection condition angle of incidence=angle of exit. The light thus reflected is incident on the deflection mirror 3a and is deflected in the direction of the light source 1. The first detector 16 does not receive a signal, because no reflected light beams 15 can travel beyond the mirror 3a. The second detector does not receive a signal either, because there is no deflection at large angles. Therefore, this measurement is a dark field measurement which produces a light signal only in response to the occurrence of defects 14. In comparison with a bright field measurement, a dark field measurement of this kind is substantially less susceptible to disturbances.

When a defect 14 occurs, the incident light 2 is scattered thereby. The scattered light 15 can be detected via the detectors 16, 17.

The nature of the defect 14 can be determined on the basis of the actuation of the two detectors 16, 17: when the defect 14 is formed by a particle resting on the surface, a major part of the scattered light is scattered at a large angle β so that it is detected by the second detector 17. When the defect 14, however, is formed by damaged area that extends into the surface 8 (pinhole), reflection takes place mainly at a small angle α, so that the first detector 16 will supply an electrical signal.

The magnitude of the defect can be determined on the basis of the signal level: the greater the signal peak obtained, the larger the defect will be (FIG. 11).

The position of the defect on a surface can also be very accurately determined; this constitutes a main point of the invention: from the setting of the optical system conducting the light beam 2 it is known where this beam is incident on the rotating wafer 13, that is, where the strip that is scanned by the light spot is situated in the radial direction. When a signal occurs in one or more of the detectors 16, 17 the instantaneous angular position of the sample holder 20 is determined by way of the decoder.

To this end, for example, an angular scale can be provided on the sample holder, said scale being automatically read by means of the decoder at the instant of reception of a signal by at least one of the detectors 16, 17. Consequently, the angle of rotation of the sample holder 20 with the wafer 13 that is arranged so as to be stationary thereon is known. In order to enable also the radial distance r to be determined as a second pole co-ordinate, the width of the signal is measured (FIG. 10). Because the defect 14 is successively irradiated by the lines 11, 12 of different intensity of the light spot 9, the signal obtained in the detectors 16, 17 constitutes an image of the interference pattern and hence also shows the varying intensities.

The signal can then be simply measured by determination of the distances between several minimum values or between several maximum values. Furthermore, it is alternatively possible to determine the frequency of the signal and to calculate the speed of the defect therefrom. Because the angular frequency co is constant, a plurality of distances Ω can also be measured for the purpose of checking and a mean value with a standard deviation can be derived therefrom. An error calculation can be performed. A very high accuracy is thus achieved in the determination of the position of the defect 14; this is possible because of the line-like configuration of the interference pattern 10 with the lines 11, 12 that extend transversely of (but not necessarily at an angle of 90° relative to) the movement of the defect 14.

On the basis of the described interference pattern the device in accordance with the invention enables sensitivities of typically from approximately 40 nm to 50 nm to be achieved while maintaining a comparatively short measuring time nevertheless. A further increase yet of the sensitivity would prolong the measuring time.

It is to be noted that the device in accordance with the invention is not only suitable for the inspection of wafers 13, but also for the inspection of arbitrary other semiconductor surfaces or other surfaces, for example, substrates provided with thin layers, surfaces of optical or magnetic storage media, CDs, DVDs, and masks for the deposition of semiconductor structures, etc.

1. A device (1) for the inspection of one or more moving surfaces (8), notably for the inspection of a rotating surface (8) of a silicon wafer (13), which device includes at least one light source (1), notably a laser light source, and a beam splitter (4) for splitting a light beam (2) that is emitted by said laser light source into at least two interfering sub-beams (5; 6) so as to realize an interference pattern (10) on the surface (8) to be inspected, characterized in that the interference pattern (10) includes a plurality of lines (11) of maximum intensity and lines (12) of minimum intensity that extend essentially transversely of the direction of movement of the surface (8).

2. A device as claimed in claim 1, characterized in that the interference pattern (10) is bounded by an elliptical envelope (9) which is stretched in the direction transversely of the direction of movement of the surface (8).

3. A device as claimed in claim 2, characterized in that the light spot (9) has a dimension of at least 1 mm in the direction of its major semi-axis.

4. A device as claimed in one of the claims 1 to 3, characterized in that the surface (8) can be moved so as to perform a rotary movement underneath the light spot (9) while the lines (11) of maximum intensity and the lines (12) of minimum intensity on the irradiated surface (8) are directed at right angles to the direction of rotation.

5. A device as claimed in claim 4, characterized in that the light reflected at the surface (8) can be detected by an intensity-sensitive detector (16; 17).

6. A device as claimed in claim 5, characterized in that no signal can be detected in the case of an ideally smooth surface (8).

7. A device as claimed in one of the claims 1 to 6, characterized in that the moving surface (8) is associated with a device for the detection of its instantaneous orientation.

8. A device as claimed in claim 7, characterized in that the surface (8) is rotatable in the plane in which it extends, and that the device enables determination of the angle of rotation.

9. A device as claimed in one of the claims 4 to 8, characterized in that the position of a defect (14) of the inspected surface relative to said scale can be derived from the signal detected by the detector (16; 17).

10. A device as claimed in one of the claims 4 to 9, characterized in that the position of a defect (14) of the inspected surface (8) relative to the longitudinal direction of the lines (11; 12) of equal intensity can be determined from the signal detected by the detector(16; 17).

11. A device as claimed in one of the claims 1 to 10, characterized in that the surface (8) to be inspected can move in a rotational and a translational mode.

12. A device as claimed in one of the claims 5 to 11, characterized in that there are provided two detectors (16; 17) that are arranged perpendicularly to one another.

13. A method for the inspection of one or more moving surfaces, notably for the inspection of a rotating surface of a silicon wafer, which surface is exposed to coherent light that is emitted by at least one light source, notably a laser light source, and is first split into at least two interfering sub-beams by means of a beam splitter, the interference pattern of said sub-beams being conducted to the surface to be inspected, characterized in that essentially the surface is moved underneath the interference pattern in a direction transversely of the direction of straight lines of maximum or minimum intensity, and that the position of a defect that is irradiated by the interference pattern is derived from the scatter signal.

14. A method as claimed in claim 13, characterized in that the reflected light makes one or more detectors produce a signal only in response to the occurrence of a defect (dark field measurement).
